(19) United States
(12) Patent Application Publication
(10) Pub. No.: US 2010/0257991 A1
(43) Pub. Date: Oct. 14, 2010

(54) Tremolo hinge bridge

(76) Inventor: Oscar Williams, Hollywood, CA (US)

Correspondence Address: Oscar Williams, #329, 1626 N. Wilcox Ave, Los Angeles, CA, 90028, US

(21) Appl. No.: 12/386,028

(22) Filed: Apr. 13, 2009

(51) Int. Cl. G10D 3/00

(52) U.S. Cl. 84/313

(57) ABSTRACT

The tremolo hinge bridge device is a three plates hinge system, locked in by two long double clamp locking bolts. This lock in the bottom springs hook plate at the back of the guitar two nut lock in this plate. The back hinge plate. The front top hinge plate. The front bottom hinge plate are all interlock by way of the back plate pivot hinge cylinder catch rod. The top springs hook plate is bolted down by two bolt into the back plate under belly with a half inch thick nut plate this lock in the top hook plate. The two hook plates are inter lock by down ward angling fixed springs. The strings saddle plate set on top of the back hinge plate, it is for adjusting the strings height to the guitar fret board and evenly spaces the guitar string.

### CROSS-REFERENCE TO RELATED APPLICATIONS

Not Applicable

### FEDERALLY SPONSORED RESEARCH AND DEVELOPMENT

Not Applicable

### BACKGROUND

1. Field of the Invention

This invention relates to the Electric Guitar Tremolo Bridge Device. The guitar player can achieve tremolo, sound effect by hand manipulation of this device.

2. Prior Art

Bigsby, vibrato and then later, fender tremolo bridge device was developed more then fifty years ago. The U.S. Patents number document this, bigsby U.S. Pat. No. 170,109 and Fender U.S. Pat. No. 2,741,146. The bigsby device is a massive metal vibrato tail piece, one spring, lever system its look is old and do not fit all guitar. The fender device is a plate with a edge, bolts screws and six individual string saddles, a tremolo arm, adjustable tension springs a tail block and a tuning problem. A massive number of new patented device, do not work as well as the out dated bigsby and fender system.

### SUMMARY OF THE INVENTION

The tremolo hinge bridge do solve the problem of prior art. The strings saddle plate 4 is, for adjusting the guitar strings height to the pret board, this set on top of the back hinge plate 3 this plate is a support for the strings plate and under this plate is a locking nut plate 11 that lock in the top springs hook plate 9 the locking nut plate is lock in by two bolts. The top hook plate is lockin, in by way of very short standard spring. The bottom springs hook, plate 10 is inter lock with the top and bottom spring hook plate. The bottom plate is connected to two bolts and two nut that go from the back of the guitar to the front of the guitar and this lock in and anchor in the three plate hinge system. A front hinge top plate 1 A front hinge bottom plate 2 and a back hinge plate 3 all make a hinge with this connection, to the back plate pivot hinge cylinder catch rod 13 the two double clamp locking bolts 7 is the locking core of the system. The springs hook plate 9 and 10 is on down ward angle and fixed.

### DESCRIPTION OF THE DRAWINGS

FIG. 1 is a right side elevation view showing the parts of the tremolo hinge bridge device.

FIG. 2 is a plan bottom view of the locking nut plate.

FIG. 3 is a right side internal structural elevation view showing the tremolo hinge bridge device.

FIG. 4 is a top front side perspective view of the string saddle plate.

FIG. 5 is a plan top view of the back plate of the trmolo hinge bridge showing the internal part of the back plate pivot hinge catch cylinder rod.

FIG. 6 is a plan top view of the front hinge top plate.

FIG. 7 is a plan top view of the front hinge bottom plate top.

FIG. 8 is a side internal elevation view of the front hinge top and bottom plate and catch hinge cylinder rod.

FIG. 9 is a side elevation view of the front hinge top and bottom plate.

FIG. 10 is a top, side, front perspective view of the top springs hook plate.

FIG. 11 is a bottom side front perspective view of the bottom springs hook plate.

### DETAILED DESCRIPTION OF PREFERRED EMBODIMENT

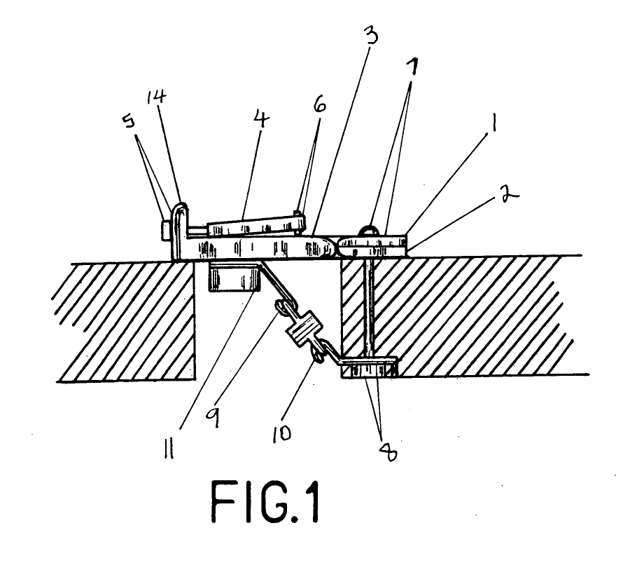

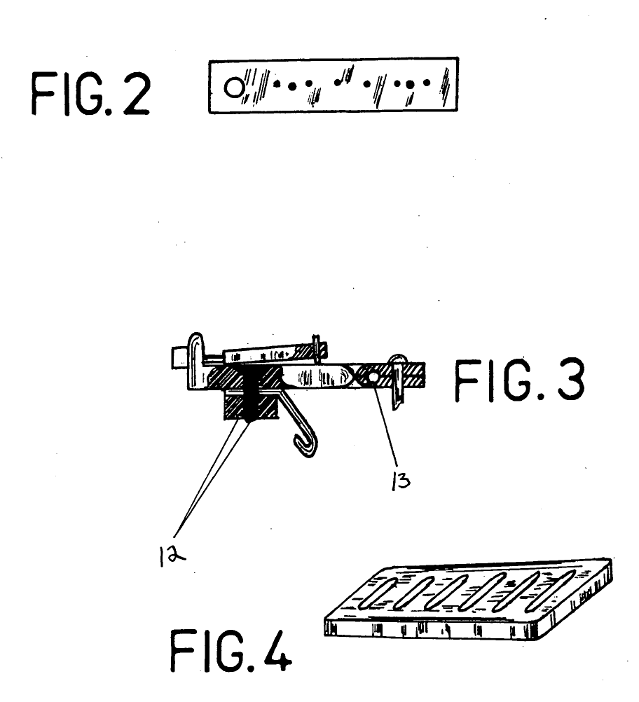

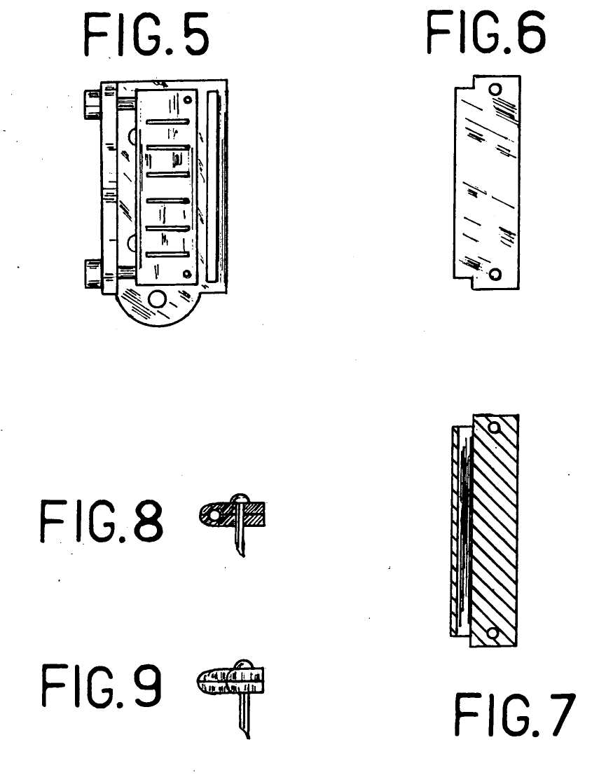

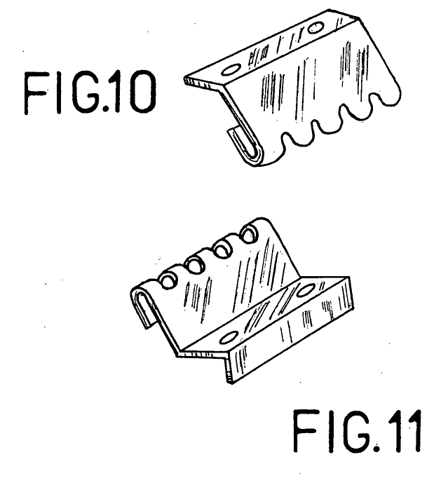

Please refer to FIG. 1 and this show the tremolo hinge bridge. A string saddle plate 4 two saddle plate height adjusting bolts from top to bottom 6 two saddle plate rear bolts 5 with back hinge plate 3 with back plate bolt arm support 14 a back plate pivot hinge cylinder catch rod 13 a front hinge top plate 1 with a front hinge bottom plate 2 two long double clamping locking bolts 7 running from front to back of the guitar body. Clamping down a bottom sprint hook plate 10 with two locking nut 8 under the back hinge plate 4 is a half inch thick locking nut plate 11 locking, in a top spring hook plate 9 with two back plate locking bolts 12.

### Method of Manufacture

The production of the tremolo hinge bridge is best done in a machine shop by machinists, who specialize in metal working. The Tremolo hinge bridge is made up of steel or iron metal. Hot melted metal is cast into mold to make all kind of metal part and almost anything. Metal forming operations all kind of technique is use, forging, machines, presses, press brakes, shears, electrochemical machining, beam cutting, high-energy rate forming and hot metal in die-mold.

### Operation of the Invention

The tremolo hinge bridge device is rocked fourth and back by a hand held tremolo arm, inertia bar, or whammy bar. The fixed springs move in and out on a down ward angle with a very strong pull.

I claim:

1. The Tremolo hinge bridge device with its three plate hinge system.
4. A strings saddle plate.
3. A back hinge plate.
13. A back plate pivot hinge cylinder catch rod.
1. A front hinge top plate.
2. A front hinge bottom plate.
7. A double clamp locking bolts.
10. A bottom springs hook plate.
11. A locking nut plate.
9. A top springs hook plate.
9 and 10. A down ward angle fixed springs system.
